(19) United States
(12) Patent Application Publication
(10) Pub. No.: US 2005/0058451 A1
(43) Pub. Date: Mar. 17, 2005

(54) Enhanced fiber infrastructure for building interiors

(76) Inventor: Barrett Ross, Castaic, CA (US)

Correspondence Address: Donald W. Mecker;Patent Agent, 924 Eash Ocean Front #E, Newport Beach, CA, 92661, US

(21) Appl. No.: 10/639,126

(22) Filed: Aug. 12, 2003

(51) Int. Cl. H04J 14/00

(52) U.S. Cl. 398/70

(57) ABSTRACT

An optical fiber-based network infrastructure in a building comprises an infrastructure of fiber optic cables throughout a building, utility boxes, junction boxes, junction processors and a single master processing hub, which interfaces between the outside world and a variety of user surfaces, controls, fixtures and modular products (devices) to be installed presently then expanded or added at anytime in the future.

### BACKGROUND OF THE INVENTION

1. Field of the Invention

The present invention relates to interior wiring systems in buildings and in particular to an optical fiber-based network infrastructure in a building having a single master processing hub to interface to the outside world, which hub would be installed at the main utility location in the building, and an infrastructure of fiber optic cables throughout the building to allow for modular products, such as a variety of user surfaces, controls and other needed fixtures to be installed presently or be developed and added at anytime in the future.

2. Description of the Prior Art

For years the ability to control anything from lighting to data has required wiring (and other infrastructure) be provided via copper cabling (either shielded or not) using a pre-designed configuration. This design assumed we would most likely never require adding feature sets or change our minds about what was desired over time.

As each new electrical appliance and/or electronic device is added to the environment, the need becomes quickly apparent that the built-in electrical wiring is inadequate to handle the growing needs for such devices. Walls must be breached to install new wiring and outlets to meet these growing needs and sometimes entire electrical and other wiring structures upgraded to meet demands.

Many commercial users have used fiber optic cables to get from one device to the next, or to transport many pieces of data to and from a location to a few others. But a fiber infrastructure topology within buildings for both residential and commercial needs was not developed in the prior art.

Research shows that many owners of buildings (including residential homes) are aware the future will bring them more, better, and cost effective products which they will soon require use of in there buildings.

The prior art fails to address the need for an interior infrastructure within a building which can address both present and future needs for wired, wireless or fiber cabled connections including controls.

Prior art U.S. Patent Application #20020023273, published Feb. 21, 2002 by Song, puts forth an apparatus for providing a multiple Internet connection service using a hybrid fiber coaxial cable network. The system provides multiple Internet connections by employing a filter, which selectively filters a transmission frequency band, on the data upstream in a cable network system. The system includes subscribers, cable modems, filters, an HFC line, CMTSs and multiple ISP host servers. Each subscriber uses a specific frequency band in data upstream using the filters. Therefore, each subscriber can be easily connected to a corresponding ISP server.

Prior art U.S. Patent Application #20020030867, published Mar. 14, 2002 by Iannone, concerns an optical wavelength-division-multiplexing (WDM) network that has mixed wavelength routing and fiber routing cross-connect switches. The WDM network has at least one transit node, where a majority of received channels are destined for a remote node, and at least one hub node, where a majority of received channels are switched to a local destination. The network follows a channel-level protection scheme, and at least one of the nodes has a cross-connect switch of a tandem design with a wavelength switch portion optically positioned in a feedback path of a space switch portion. Alternatively, the transit node has a tandem switch design, where the space switch interfaces with the network fibers, and the hub node has at least a wavelength switch that interfaces with the network fibers. The capacities of the respective wavelength and space switch portions of the tandem cross-connect are configured according to the expected ratio of local traffic to pass through traffic.

Prior art U.S. Patent Application #20020033977, published Mar. 21, 2002 by Birk, illustrates a system for flexible multiple broadcast service delivery over a WDM passive optical network based on RF block-conversion of RF service bands within wavelength bands. The system and method are for simultaneous delivery of a plurality of independent blocks of 500 MHz digital broadcast television services, by stacking a plurality of RF blocks on a plurality of spectrally sliced WDM optical bands. The method for delivering a plurality of video blocks to a user terminal serviced by a remote node comprises the steps of receiving, by a first WDM, a broadband signal from a broadband signal source. Next to separate, by the first WDM, the broadband signal into a plurality of optical bands and modulate each of the plurality of optical bands with a composite signal representing data in a plurality of independent RF blocks to form a plurality of modulated signals. Then to forward the plurality of modulated signals to a second WDM to form a combined broadcast signal. The next step is to transmit the combined broadcast signal over feeder fiber to a remote node, select an RF block for distribution over a distribution fiber to a conventional satellite set-up box at a user's site and forwarding the selected RF block to said user's site. A novel method and system for reducing spontaneous beat noise is also described.

Prior art U.S. Patent Application #20020057709, published May 16, 2002 by Edmon, is for a method and apparatus that enables multiple access on a broadband communication network. A protocol is provided for handling multiple access on broadband communication networks, e.g., fiber/coax networks and wireless networks, which supports both continuous bit rate (CBR) and variable bit rate (VBR) traffic representing voice, video telephony, interactive television, and data. The invention is carried out both in customer premise equipment (CPE) at stations, and in a common controller with which all stations communicate. A medium access control (MAC) processor provided in each of the stations and in the common controller divides the time domain for a given RF channel into a series of successive frames, each having a plurality of time slots. Because of the architecture of the communication network, individual stations do not communicate directly with each other, but can receive broadcast messages indicating the status of each time slot, which messages are generated in the common controller and transmitted in a downstream channel. When a station desires to transmit information in the upstream direction, it inserts the information into an available time slot, with availability being determined in accordance with time slot status. Depending upon the type of traffic being originated, a station can indicate to the common controller a need for continued use of the “same” time slot in successive frames. This permits a station, such as a station requiring a CBR connection, to avoid having to contend repeatedly for continued access to the transmission network. In the case of a wireless communication network, the invention is carried out both in mobile stations and in a base station, which acts as a common controller and with which all mobile stations communicate.

Prior art U.S. Patent Application #20020071159, published Jun. 13, 2002 by Lange, depicts a network transceiver that extends the bandwidth of an optical fiber-based network infrastructure. A multimode wavelength division multiplexing (WDM) network transceiver and method is provided, which includes a plurality of optical transmitters and a multiplexer operatively connected to each optical transmitter for receiving optical communications signals and multiplexing the signals into a multimode wavelength division multiplexed optical communications signal. A demultiplexer receives a multimode wavelength division multiplexed optical communications signal and demultiplexes the signal into a plurality of demultiplexed optical communications signals that are then received and detected within a plurality of optical receivers.

Prior art U.S. Patent Application Ser. No. 20020090001, published Jul. 11, 2002 by Beckwith, provides a wireless communications hub with protocol conversion for use in an electric utility substation, the hub provides two-way wireless communications digital information between the hub and associated IEDs. The hub includes a protocol processor, a data processor and a Scada processor. The data processor exchanges two-way digital information with IEDs by using protocols of said IEDs. The Scada processor exchanges two-way digital information with an external source that has its own protocol, and the protocol processor converts two-way digital information between protocols of said IEDs and the protocol of an external source. The hub includes circuits that permit any one of the three processors to select either of the other two processors to exchange digital information with the chosen processor.

Prior art U.S. Patent Application #20020181044, published Dec. 5, 2002 by Kuykendall, shows a method and system that uses holographic methodologies for all- optical transmission and reception of high bandwidth signals to and from end-users to serve video, telephony and Internet applications. The optical transmission system includes a plurality of service provider systems that provide transmission-based services; a plurality of end-user devices receiving transmission-based services and a central hub node including a first plurality of terminals for supporting bi-directional transmission of optical signals between the plurality of service provider systems and the central hub node and a second plurality of terminals for supporting bi-directional transmission of optical signals between the end-user devices and the central hub node. The system further includes a first transmission network coupled between the plurality of service provider systems and the plurality of first terminals of the central hub node for enabling the bi-directional transmission of optical signals between the plurality of service provider systems and the plurality of first terminals of the central hub node and a second transmission network coupled between the plurality of end-user devices and the plurality of second terminals of the central hub node for enabling the bi-directional transmission of optical signals between the plurality of end-user devices and the plurality of first terminals of the central hub node. The bi-directional optical transmission between each of the plurality of end-user devices and the central hub node occurs at a dedicated wavelength that is unique to each end-user device.

Prior art U.S. Patent Application #20020186433, published Dec. 12, 2002 by Mishra, claims routing and switching in a hybrid network. A protocol-independent framework facilitates routing and switching in a network that has hybrid nodes. Using the framework, optical paths are established between and among nodes statically and dynamically. When the paths are established dynamically, the paths maybe explicitly established or shared. Traffic is transported using switching wavelengths, routing wavelengths, and/or control wavelengths. Traffic transported on switching wavelengths is switched in the optical domain. Traffic transported on routing wavelengths is routed according to the OSI reference model.

Prior art U.S. Patent Application #20020186431, published Dec. 12, 2002 by Bisson, describes a method of organizing wavelength channels in a wavelength-division multiplexed network, as well as an optical wavelength-division multiplexed network, optical hub, optical add/drop multiplexer and optical filter bank therefore. The invention relates to a method in a wavelength-division multiplexed (WDM) network to organize wavelength channels between optical nodes of said WDM network, wherein the nodes each have optical filters for selecting a first set of wavelengths with respect to a set of other wavelengths and wherein, in each case, the wavelengths of one of these sets are forwarded and the other set of wavelengths is dropped. At least one node has both at least one statically preset optical filter and at least one optical filter that can be dynamically tuned during operation and in that only respective dynamic optical filters in the affected nodes have to be tuned in the event of a dynamic reconfiguration of channels, and also to an optical wavelength multiplexed (WDM) network, an optical hub and an optical add/drop multiplexer for the purpose.

Prior art U.S. Patent Application #20020186699, published Dec. 12, 2002 by Kwok, discloses a system and method that provides high-speed communications access over an electrical network of a building. A host unit disposed inside the building is coupled to the communications network via a connection device. The host unit is also coupled to the electrical network of the building via a power distribution point of the building. A subscriber unit disposed inside the building is also coupled to the electrical network and is in communications with the host unit via the electrical network of the building. Signals provided by the communications network reach the subscriber unit via, for example, the public telecommunications network equipment, the connection device, the host unit and the electrical network of the building.

Prior art U.S. Patent Application #20030011842, published Jan. 16, 2003 by Szechenyi, puts forth a system for optically transmitting information, e.g., television signals, from a subcenter (HUB), e.g., a cable television head end, over a passive optical distribution network to a plurality of optical network units, which includes a plurality of nodes for optically transmitting further information, e.g., telephone signals, and a plurality of optical couplers. The further information of each node is fed via a respective coupler into a transmission line connected to only part of the plurality of optical network units, e.g., to only one optical network unit. Each optical network unit is connected to a group of customer locations and, for the transmission of information from this group of customer locations, via a further passive optical distribution network to a node. Each node includes means for separating the information received from the customer locations into, e.g., interactive request signals and telephone signals. The interactive request signals are routed to the subcenter (HUB), and the telephone signals to a telephone network.

Prior art U.S. Patent Application #20030016932, published Jan. 23, 2003 by Glynn, indicates a telecommunications fiber optic infrastructure. An apparatus and process (collectively referred to as a “Fiber Center”) is disclosed, which is used for deploying and managing a central office fiber optic telecommunications infrastructure in response to demand from either a customer location or another operating telephone company (OTC) location. Customer demand information and management parameters are entered into a software system. In response to the demand information, the software system describes the required standard components and prefabricated cables, assigns the standard components and prefabricated cables to a specific location and enters this information into a reference database. Assembly of the fiber optic infrastructure is implemented according to an equipment order, which is generated based on the description and location information in the reference database.

Prior art U.S. Patent Application #20030048501, published Mar. 13, 2003 by Guess, illustrates a local access fiber optical distribution network in which a dedicated pair of diversely routed optical fibers is routed in the distribution network for each customer. In a preferred embodiment, a dual physical overlay ring core topology is used in the core. The distribution network includes working and protection logical path connectivity. No 802.1D Spanning Tree is required for recovery, and provides resilience to any single network failure in any device or link, quick recovery times from failure, and a failure detection/recovery protocol that is not active on any devices other than the devices directly attached to the subscriber.

Prior art U.S. Patent Application #20030066087, published Apr. 3, 2003 by Sawyer, is for a digital transmission system that has modulators remotely located from central media access control layer, which comprises hybrid distributed cable modem termination systems that have mini fiber nodes containing CMTS modulators remotely located from the head end. DOCSIS MAC layer components are located at the head end. This lowers cost and allows use of a smaller mFN enclosure. The mFN has A/D converters for DOCSIS upstream traffic and for legacy upstream traffic. A multiplexer that uses forward error correction combines the legacy and DOCSIS traffic for upstream transmission along a single fiber at rates of approximately 2 Gbps. A splitter at the head end routes legacy traffic to legacy equipment and the DOCSIS traffic to the MAC layer components. A single power supply at the head end can be used to power the mFNs.

Prior art U.S. Pat. #4,736,465, issued Apr. 5, 1988 to Bobey, provides a communications network, which comprises a digital optical fiber communications system that includes a plurality of communications nodes, each of which may include a processor, at each of a plurality of different locations. For packet data communications among the processors a communications network comprises a first set of unidirectional communications loops, each at a respective location for communications among the processors at the respective location; and a second set of unidirectional communications loops, multiplexed onto the optical fiber channels, for communications among processors at different locations. Data packets are broadcast on both sets of loops throughout the network so that they reach all processors even in the presence of severe failures among the optical fiber channels, thereby providing a very reliable processor communications facility.

Prior art U.S. Pat. #4,866,699, issued Sep. 12, 1989 to Brackett, shows an optical telecommunications system that uses code division multiple access, which is capable of setting up connections between particular pairs of subscriber stations. Illustratively, the Fourier components of radiation pulses produced in a first specific subscriber station are independently phase modulated in accordance with a predetermined code chosen so that the radiation pulse can be detected only in a second specific subscriber station.

Prior art U.S. Pat. #4,911,515, issued Mar. 27, 1990 to So, claims an optical fiber communications system with optical fiber monitoring, in which optical communications fibers extend from a central office to subscribers' premises for carrying signals in both directions between optical transmitters and receivers. Each subscriber's optical receiver continuously reflects back to its fiber, and then to the central office, about 20 percent of the light which it receives. At the central office the reflected light is monitored in turn for each subscriber, and is correlated with the signal transmitted to that subscriber to provide a signal for optical time domain reflectometry of the respective subscriber's fiber connection.

Prior art U.S. Pat. #5,394,402, issued Feb. 28, 1995 to Ross, describes a hub for a segmented virtual local area network with shared media access that has at least one internal port for receiving and transmitting digital data messages within the hub and may have at least one external port for receiving and transmitting digital data messages external to the hub. The hub further includes a memory for storing virtual local area network (VLAN) designations for internal and external ports. The hub associates VLAN designations with at least one internal port, stores such VLAN designations in the memory, and associates the stored VLAN designations with messages transmitted from any of the ports to which the VLAN designation has been assigned. Additionally, the hub identifies VLAN designations associated with messages received by or within the hub and means and transmits to any of the internal ports only messages received within the hub and having associated with them a VLAN designation which matches the stored VLAN designation assigned to the port. The hub also has the ability to store media access control (MAC) addresses of internal ports and of end stations connected to internal or external ports and only send a message to a port when the destination address of the message is the MAC address of that port or of an end station known to be reachable through that port.

Prior art U.S. Pat. #5,808,767, issued Sep. 15, 1998 to Williams, discloses a fiber optic network with wavelength-division-multiplexed transmission to the customer premises. The fiber optic network comprises an optical fiber connection (one fiber or two) from a central office to an intelligent interface device in the subscriber's premises. The central office includes a serving node transceiver that provides communication links to/from at least a narrowband switch and a broadband switch for providing narrowband and broadband service routing. The network includes at least one passive power splitter/combiner for passing all wavelengths on the optical fiber connection between the serving node transceiver and the intelligent interface devices. All wavelengths are provided to each customer and bandwidth on the optical fiber loop is dynamically allocated for individual services on demand through two-way wavelength division multiplexing and demultiplexing as well as any necessary signal format conversions. The network has media access control functionality and utilizes a dynamic media access control procedure for allocation of the bandwidth.

Prior art U.S. Pat. #5,963,350, issued Oct. 5, 1999 to Hill, indicates an optical telecommunication system that includes a number of transparent passive optical networks (TONs). Each TON connects a respective group of terminals and the head end of each TON is connected to a common central switching node. Each terminal includes selecting a wavelength/time channel for forming a connection with another terminal within the respective TON or within another TON. The central switching node comprises an optical spatial/wavelength switch arranged to provide switched connections between subscribers connected to different TONs.

What is needed is to have a fiber optic infrastructure installed throughout a home, office, or commercial building(s), which would provide an infrastructure adequate to handle the needs of the building for years to come, and which would not require replacing or modifying the infrastructure each and every time a feature, function or product is desired.

### SUMMARY OF THE INVENTION

An object of the present invention is to provide a fiber optic infrastructure installed throughout a home, office, or commercial building(s), which provides an infrastructure adequate to handle the needs of the building for years to come, and which does not require replacing or modifying the infrastructure each and every time a feature, function or product is desired.

Another object of the present invention is that it provides a cost-effective infrastructure for present and future wiring and control needs inside buildings.

One more object of the present invention is that it provides a main I/O hub that can control or monitor incoming services such as telephone lines, broadband data, CATV, utilities, satellite signals, etc.

An additional object of the present invention is that it provides a main I/O hub that can be connected to security or fire monitoring systems.

A further object of the present invention is that it provides a main I/O hub that has RFI and EMI protection, multiple fiber optic I/O port capability, optional dual redundant processors and modular software, which would be installed by the manufacture, installer (or client) with each additional aspect usage.

A contributory object of the present invention is that it provides a main I/O hub that can control and/or monitor building environmental and human environmental requirements.

In brief, an enhanced fiber optic infrastructure for residential and commercial applications within a building is comprised of a single (or more) fiber optic cable(s) installed through out a building. A single master-processing hub is installed at the main utility location in the building. The hub interfaces to the outside world; incoming mains—AC power, cable TV, phone, satellite dish, air conditioning, water, natural gas, fire and security systems, and other future incoming systems directly (via copper, coax, fiber or any future desired method) into the fiber optic infrastructure within the building as programmed by the hub or controlled via a fiber optic control connected to the incoming system and programmed by the hub. This includes all lighting, all environmental I/O (water, gas, air conditioning, etc.), all audio, video, cable, satellite signal (possibly even reception control), infrared remotes, fire and security system(s), computer networking (computers, printers, etc.) including all high-speed data external to the building (i.e.; Internet or other future telecommunications requiring much greater bandwidth than just broadband), and other possible systems developed in the future which can be interfaced with fiber optics enabled by the wide bandwidth afforded by fiber optic cable.

A single (or many) fiber cable(s) (varying in specification depending on the scope of the building and network hub) would be installed throughout both the ceiling and either floors or walls (depending on the scope of the project). The fiber cable(s) would be connected to/from the utility room “hub” on one end and physically routed through possibly larger than normal utility boxes at or near each of the major desired points of interest. Each of these larger utility boxes would be DC powered and preferably employ a “junction processor” and a unique electronically coded identifier for it's specific location. Some of the junction processors functions would be (and not limited to) fiber receiver(s) & transmitter(s) and; analog to digital and digital to analog electronics for I/O connectors, light controller(s), switch/light panel(s), and the facilities for adding both wireless devices (if needed) and/or other manufacturer's add-on products, features, and other future systems.

Connected to each of the larger utility boxes (via fiber interfacing) are several smaller electrical junction boxes (possibly standard in size). These smaller junction boxes would be DC powered and have a unique electronically coded identifier for it's specific location. Some if the smaller junction boxes functions may be (and not limited to); analog to digital and digital to analog electronics for I/O connectors, switch/light panels, sensors, etc. These smaller junction boxes can also have some facilities for adding wireless devices (if needed) and/or other add-on future products and features, etc.

The data on each of the fibers (within the single cable) is preferably the same throughout the building. Thus, the functions (data) could be accessed (via fiber splitter or other means) anywhere in the building with just simple hub programming.

A single hub is installed at the main utility room location in the building. The hub interfaces to the outside world, incoming mains—AC power, cable TV, phone, satellite dish, air conditioning, water and natural gas systems, fire and security and other required or future systems.

The hub is the hub of the buildings environmental and human environmental requirements. This includes all lighting, all environmental I/O (water, gas, air conditioning, etc.), all audio, video, cable, satellite signal (possibly even reception control), infrared remotes, security and fire monitoring system(s), computer networking (computers, printers, etc.) including high-speed external building access (i.e.; Internet or other telecommunications requiring much greater bandwidth other than just what is available. today) and other systems.

The hub is capable of having one or more external UPS's (uninterruptible power system) attached to it. This way the hub can monitor all power consumption and distribution. The hub's internal electronics (processing) would be properly protected against both external power EMI (Electro-Magnetic interference) and RFI (Radio Frequency interference) interruption & surges. This is assisted by having optionally redundant processing electronics and processing power systems on board.

The hub would be pre-programmed by the factory and final programmed by the installing contractors technical personnel. The user would also have the ability to program the hub for signal routing of audio, video, remote control systems, computer networking, lighting configurations and more. Furthermore, the factory could be given program access (by the user or installer) at any time. This access would provide the factory not only control of the hub, it would provide the factory full control of the system, including all routing, and control mapping. Thus allowing the factory to better understand the hub's intended installation and application(s). Any programming changes could be undone (or redone) by the user for some time period after they are made. Many user levels of programming would be available for the variety of users. Many user presets and memories would also be available for quick recall when necessary (especially lighting, security, remote systems, etc.).

Once the new fiber infrastructure topology is installed, any of the optional panels, surfaces, lighting, etc. can be added and programmed. Those customers having only the raw fiber cable system infrastructure properly installed, would reap the benefits of significantly adding value to there home(s) or building(s).

An operating fiber system could be a standard system for any mid to high priced home and almost any commercial building being built or remodeled today. This would be possible by the customer making the decision upon construction (or remodeling), to have the raw fiber cable system infrastructure properly installed from the start. The customer could then choose as to how much (if any) hub control/features are desired. Some customers at first may only desire the hub system for lighting, security, computer networking and of course Internet. Thus, the installation cost of the raw fiber infrastructure could pay for itself from the very beginning, and later be a huge value added feature for future building owners and/or occupants.

Modular products, such as a variety of user surfaces, controls and other needed fixtures may be added at anytime in the future. Just a sample of these different surfaces, control panels and fixtures would include:

a) Security panel(s) (for alarm of other uses)

b) Audio/Video control & routing panel(s)

c) Data (computer) network routing panel(s)

d) Lighting controls and/or Lighting program controls (some w/security programs)

e) Audio volume and source programming panel(s)

f) Utility (power, water, gas) usage metering and user alarm(s) monitoring

g) Powered speakers (background music, surround sound, intercom, etc.)

h) Keypads for programming of security systems, refrigerator, appliances, etc.

i) RF and/or infrared receivers for garage door & other products or applications

j) And other systems

An advantage of the present invention is that it provides all encompassing control over incoming services and utilities, monitoring systems, computer networks, appliances, lighting, etc.

Another advantage of the present invention is that it provides a fiber optic infrastructure that can have new modular products, such as a variety of user surfaces, controls and other needed fixtures added at anytime in the future.

An additional advantage of the present invention is that it can be accessed (via fiber splitter or other means) anywhere in the building with simple hub programming.

One more advantage of the present invention is that the hub is properly protected against both external power EMI (Electro-Magnetic interference) and RFI (Radio Frequency interference) interruption & surges.

Another advantage of the present invention is that the hub is pre-programmed by the factory and final programmed by the installing contractors technical personnel.

Yet another advantage of the present invention is that any programming changes can be undone (or redone) by the user for some time period after they are made.

Still another advantage of the present invention is that it is cost effective and provides a huge value added feature for future building owners and/or occupants.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a diagrammatic view of the fiber optic infrastructure, including the hub, of the present invention.

### BEST MODE FOR CARRYING OUT THE INVENTION

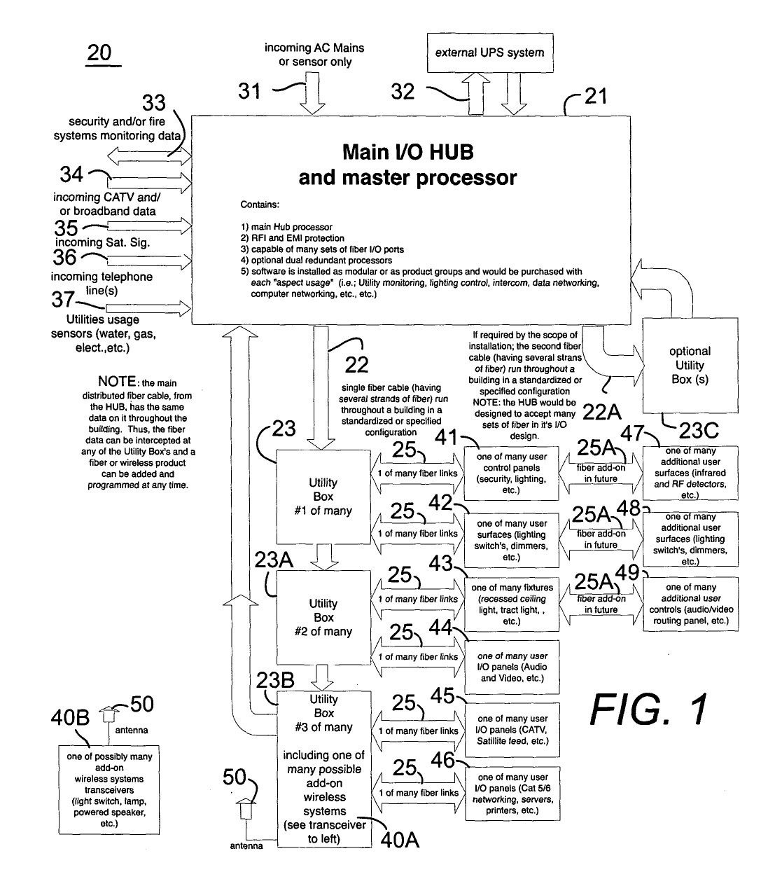

In FIG. 1, an enhanced fiber optic infrastructure system 20 for residential and commercial applications within a building comprises one or more fiber optic cables 22 installed in a building structure that has floors walls and ceilings. The fiber optic cable 22 extends through the building structure positioned in proximity to actual and potential locations of devices 41-49 in the building structure. The devices 41-49 are interactively connected to the fiber optic cable 22 via a fiber cable 25 (as needed) through a utility box (described below). The fiber optic cable 22 comprises a plurality of fibers within the fiber optic cable 22 and carries data on each of the fibers within the fiber optic cable 22, wherein the data could be the same throughout the infrastructure. The fiber optic cable 22 further comprises a fiber splitting means (not shown) and provides access to the data via the fiber splitting means anywhere in the building with hub 21 programming.

The fiber optic infrastructure system 20 also comprises one or a series of utility boxes 23, 23A, 23B and 23C positioned within the building structure. The utility boxes 23, 23A, 23B and 23C interconnect to the fiber optic cable 22. The fiber optic cable 22 and one or a series of utility boxes form a fiber optic infrastructure. Each of the utility boxes 23, 23A, 23B and 23C are DC powered and each have a junction processor (not shown) and a unique electronically coded identifier for it's specific location. A function of these utility boxes (and internal junction processors) may include a fiber optic receiver, a fiber optic transmitter and contain analog to digital and digital to analog electronic devices for I/O connector panel(s), lighting controller(s), switch panel(s), a facility for adding wireless devices, a facility for adding other manufacturer's add-on products and a facility for adding new features and other systems in the future. The primary function of these utility box(s) is to provide the gateway interface to both the user devices (as described above and below) and/or the following electrical junction box(s).

The system 20 further comprises at least one electrical junction box 41-49 (containing one or more devices) connected to each of the utility boxes 23, 23 A and 23B via optic fiber interfacing 25 or 25A. The junction boxes 41-49 are DC powered and each have a unique electronically coded identifier for it's specific location. Each junction box 41-49 is connected to the system (via fiber, wireless or other means) and includes analog to digital and digital to analog electronics, to name a few, used to support I/O connector panel(s), switch/light panels, sensors, wireless devices and other add-on products in the future.

The fiber optic infrastructure system 20 further comprises a single master processing hub 21 installed at a main utility location in the building structure. The hub 21 can be programmed and interfaces with many incoming systems 31-37 (as an example) from the outside coming into the building structure. The incoming systems 31-37 are connected directly into the fiber optic infrastructure 20A within the building structure, then as programmed by the hub 21, the data is routed, distributed or allowed to/from each of the incoming systems 31-37 to/from one or more of the series of utility boxes 23, 23A, 23B or 23C for the appropriate function(s) required. Alternately, the incoming systems 31-37 are controlled by the hub 21. The hub 21 can be pre-programmed with a plethora of user presets and memories, which would be available for quick recall and use as desired. The hub 21 can also be programmed remotely.

The incoming systems 31-37 from the outside coming into the building structure, programmed and controlled by the hub 21, include AC power 31, cable TV 34, telephone 36, satellite dish 35, air conditioning (not shown), water systems 37 and natural gas systems 37 and others. The incoming systems 31-37 that are interfaced into the fiber optic infrastructure within the building structure as programmed by the hub 21 may include all room and specialty lighting for occupants, all environmental I/O (water, gas, air conditioning, etc.) 37, all audio (not shown), video (not shown), cable 34, satellite signal 35 (possibly even reception control), infrared remotes, security system(s) 33, computer networking (computers, printers, etc.) including all high-speed data external to the building 34 (i.e.; Internet or other future telecommunications requiring much greater bandwidth than just broadband), and other possible systems developed in the future which can be interfaced with fiber optics enabled by the wide bandwidth afforded by the fiber optic cable system 22, 22A, etc.

The system 20 can receive a variety of user surfaces 42, control panels 41 and fixtures 43 and modular products 44-49, which may be added at anytime in the future. The user surface 42, control panel 41, and fixtures 43 may include: a security panel (for alarm and other uses), an audio/video control and routing panel, a data (computer) network routing panel, a lighting control and/or lighting program control (some with security programs), an audio volume and source programming panel, a utility (power, water, gas) usage metering and user alarm monitoring, a powered speaker (back ground music, surround sound, or intercom), a keypad for programming of security systems, refrigerator, appliances, etc., and an RF and/or infrared receivers for garage door and other products or applications.

The modules for user control 41 are comprised of modules that may include a security panel (for security, fire alarm or other uses), an audio/video control and routing panel, a data (computer) network routing panel, a lighting control, a lighting program controller (possibly a subset of security programming and/or home automation), an audio volume and source program panel, an intercom (with audio and/or video), an infrared remote I/O sensor, and other present or future system(s) controls.

The modules used as user surfaces 42 (and fixtures 43) may be comprised of a lighting input interface (sensing, switching, dim, etc.), lighting output interface (interfaced directly to a light fixture), an infrared remote sensing panel, an alarm control, a zones display, a security with live video display, a utility (power, water, gas) usage and user alarms, a powered speaker (background music, surrounds etc.), a keypad for security or refrigerator programming, an intercom panel (with audio and/or video), an RF receiver for garage door and other applications, and other present or future system(s) user surfaces.

The modules used for I/O 44-46 maybe include an audio (low level for A/V) with a variety of connector types, an audio (high level for A/V speaker use), a video (analog, composite, component & S type), a video (HD, SDI, etc.), a cable and satellite signal RF (F or BNC), a Cat 5 or 6e (sets of connectors for data or voice), an infrared remote I/O interface, a GPI input and output interfaces on multi-pin (for triggering other non intelligent devices), a sensing input and output interface on a variety of connections and multi-pin standards, and other present or future system(s) I/O requirements.

It is understood that the preceding description is given merely by way of illustration and not in limitation of the invention and that various modifications may be made thereto without departing from the spirit of the invention as claimed.

1. An enhanced fiber optic infrastructure system for residential and commercial applications within a building, the system comprising:
at least one fiber optic cable installed in a building structure having floors walls and ceilings, the at least one fiber optic cable extending through at least a portion of the building structure positioned in proximity to actual and potential locations of devices in the building structure, the devices being capable of interactive connection to the at least one fiber optic cable;
one or a series of utility boxes positioned within the building structure, the utility boxes capable of interconnecting the devices to the at least one fiber optic cable and to wireless systems, each of the utility boxes having a junction processor and a unique electronically coded identifier for it's specific location, the at least one fiber optic cable and the series of utility boxes forming a fiber optic infrastructure;
a single master processing hub installed at a main utility location in the building structure, the hub capable of being programmed, the hub interfacing incoming systems from the outside coming into the building structure, the incoming systems being interfaced directly into the hub and fiber optic infrastructure within the building structure, then programmed by the hub routing each of the incoming systems to at least one of the series of utility boxes and devices.

2. The system of claim 1 the incoming systems from the outside coming into the building structure controlled as programmed by the hub comprises at least one incoming system taken from the list of incoming systems including AC power, cable TV, telephone, satellite dish, air conditioning, water and natural gas systems.

3. The system of claim 1 wherein the incoming systems being connected directly into the fiber optic infrastructure within the building structure as programmed by the hub comprises at least one system from the list of systems including all lighting, all environmental I/O, all audio, video, cable, satellite signal, satellite reception control, infrared remotes, security systems, computer networking, computer peripherals, all high-speed data external to the building, Internet systems, ethernet systems, telecommunication systems requiring much greater bandwidth than just broadband, and other possible systems developed in the future which can be interfaced with fiber optics enabled by the wide bandwidth afforded by fiber optic cable.

4. The system of claim 1 wherein a function of the junction processors comprises a function taken from the list of functions including a fiber optic receiver, a fiber optic transmitter, an analog to digital and digital to analog electronics for I/O connectors, a light controller, a switch/light panel, a facility for adding wireless devices, a facility for adding manufacturer's add-on products, a facility for adding features, and a facility for adding other systems in the future.

5. The system of claim 1 further comprising at least one electrical junction box containing a device, the electrical junction box connected to one or the series of utility boxes via optic fiber interfacing or wireless interfacing, the junction boxes and the utility boxes being DC powered and each of the junction boxes and the utility boxes having a unique electronically coded identifier for it's specific location.

6. The system of claim 5 wherein the at least one junction box is capable of being connected to a system taken from the list of systems including analog to digital and digital to analog electronics for I/O connectors, switch/light panels, sensors, wireless devices, and other add-on products and features.

7. The system of claim 1 wherein the at least one fiber optic cable comprises a plurality of fibers within the at least one fiber optic cable is capable of carrying data on each of the fibers within the at least one fiber optic cable, wherein the data may be the same throughout the infrastructure, and further comprising a fiber splitting means, and the at least one fiber optic cable is capable of providing access to the data via the fiber splitting means anywhere in the building with hub programming.

8. The system of claim 1 wherein the hub is capable of being pre-programmed.

9. The system of claim 8 wherein the hub is capable of being pre-programmed with a plethora of user presets and memories which would be available for quick recall and use as desired.

10. The system of claim 1 wherein the hub is capable of being programmed remotely.

11. The system of claim 1 wherein the system is capable of receiving and functioning with a large variety of user surfaces, control panels and fixtures and modular products, which may be expanded and/or added at anytime in the future.

12. The system of claim 11 wherein the user surface, control panel, and fixture is selected from the group of user surfaces, control panels, and fixtures including all security panels for alarm and other uses, audio/video control and routing panels, computer data network routing panels, lighting controls, lighting program controls, security programs, audio volume and source programming panels, power, water and gas utility usage metering and user alarm monitoring panels, powered music speakers, powered surround sound speakers, powered intercom speakers, keypads for programming of security systems, refrigerators, appliances, RF receivers and infrared receivers for garage doors, and other products and applications.

13. The system of claim 11 wherein a module for user control comprises a module from the list of modules including security panels, fire alarms, audio/video control & routing panels, computer data network routing panels, lighting control, lighting program controller, security/lighting program controller, audio volume and source program panels, audio and video intercom panels, infrared remote I/O sensor, and other present and future systems panels.

14. The system of claim 11 wherein the modules used as user surfaces comprise lighting input interfaces, lighting output interfaces, infrared remote sensing panels, alarm controls, zones displays, security with live video displays, power, water and gas utility usage and user alarms, powered music speakers, powered surround speakers, powered intercom speakers, keypads for security, keypads for refrigerator programming, intercom audio remote panels, intercom video remote panels, RF receivers for garage door and other applications, and other present and future required systems surfaces.

15. The system of claim 11 wherein the modular module for I/O comprises a modular module selected from the list of modular modules including low level audio, high level audio, analog video, composite video, component video, S type video, HD video, SDI video, cable and satellite signal RF, Cat 5 sets of connectors, 6e sets of connectors, infrared remote I/O interfaces, GPI input and output interfaces on multi-pin, sensing input and output interfaces having a variety of connections and multi-pin standards, and other present and future required systems I/O connection types.
